(19) United States
(12) Patent Application Publication
(10) Pub. No.: US 2002/0184503 A1
(43) Pub. Date: Dec. 5, 2002

(54) Watermarking

(76) Inventors: Antonius Adrianus Cornelis Maria Kalker, Eindhoven (NL); Jaap Andre Haitsma, Eindhoven (NL); Minne Van Der Veen, Eindhoven (NL); Alphons Antonius Maria Lambertus Bruekers, Eindhoven (NL)

Correspondence Address: Michael E. Marion, U.S. PHILIPS CORPORATION, Intellectual Property Department, 580 White Plains Road, Tarrytown, NY, 10591, US

(21) Appl. No.: 10/139,199

(22) Filed: May 6, 2002

(30) Foreign Application Priority Data
May 8, 2001 (EP) 01201688.7

(51) Int. Cl. H04L 9/00

(52) U.S. Cl. 713/176

(57) ABSTRACT

Disclosed is a non-frame-based method and an arrangement for embedding a watermark in an information signal (x(n)), e.g. an audio signal. The method comprises calculating (101) a non-cyclic convolution of the information signal with a watermark signal (v(n)) and combining (102) the convolution with the information signal. The non-cyclic convolution may be calculated by overlapped Fast Fourier transform filtering.

This invention relates to embedding a watermark in an information signal. The invention further relates to detecting a watermark embedded in an information signal.

In recent years, an increasing trend towards the use and distribution of digital multimedia data has led to an increased need for adequate copy protection, copyright protection, and ownership verification of such data.

Digital watermarking is an emerging technology that may be used for a variety of purposes, such as proof of copyright ownership, tracing of illegal copies, controlling copy control equipment, broadcast monitoring, authenticity verification, adding auxiliary information into multimedia signals, etc.

A watermark is a label which is embedded in an information signal by slightly modifying samples of the signal. Preferably, a watermarking scheme should be designed such that the watermark is imperceptible, i.e. that it does not affect the quality of the information signal significantly. In many applications, the watermark should further be robust, i.e. it should still be reliably detectable after possible signal processing operations. In the field of audio signals, examples of such processing operations include compression, cropping, D/A and A/ID conversion, equalization, temporal scaling, group delay distortions, filtering, and removal or insertion of samples.

Though many schemes of watermarking of still images and video have been published, there is relatively little literature on audio watermarking. Most of the published techniques employ methods such as echo-hiding or noise addition, exploiting temporal and/or spectral masking models of the human auditory system.

The proceedings of the ACM multimedia 2000 workshops, Oct. 30-Nov. 3, 2000, Los Angeles (Pages 119-122) disclose an embedding technique operating in the frequency domain. According to this prior art method, an audio signal is segmented into frames, and the individual frames are Fourier transformed. For each of the frames, the resulting Fourier components are slightly modified, and the watermark signal in the time domain is obtained as the inverse Fourier transforms of the modified frequency components. Finally, the watermark signal is scaled and added to the audio signal. It is known from this prior art method that multiplicatively modifying the frequency components of a signal yields robust and perceptually transparent watermarking schemes.

However, the above prior art method involves the problem that watermarking artefacts may occur at the frame boundaries. In the case of an audio signal, these artefacts may be perceived as clicking sounds by a listener.

The above and other problems are solved by a method of embedding a watermark in an information signal, the method comprising the steps of calculating a convolution of the information signal with a predetermined key sequence representing the watermark to obtain a convolution sequence, and combining the convolution sequence with the information signal. Consequently, the method according to the invention provides a watermarking scheme which meets high robustness and perceptibility requirements without suffering from boundary artefacts.

As the method according to the invention is based upon convolving the information signal with a watermark rather than modifying individual frames of the information signal, the method according to the invention overcomes the problems due to frame artefacts in the above-mentioned prior art technique.

As the convolution of the information signal with the watermark may be interpreted as a multiplication in the Fourier domain, the advantages of a multiplicative modification of frequency components are preserved. Hence the method according to the invention yields robust and imperceptible watermarks.

It is a further advantage of the invention that the watermark detection is not sensitive to the synchronisation of frames during embedding and detection, thereby providing a watermark which may be reliably detected.

It is a further advantage of the invention that the modification of a sample is independent of any chosen frame boundaries. Hence, the modification is not sensitive to, for example, an adding or deletion of samples at the beginning of an audio stream.

Furthermore, in an advantageous embodiment of the invention, the predetermined key sequence may be generated by calculating a transform of a predetermined watermark sequence. The transform may be an inverse Fourier transform. Alternatively, other transformations may be used, for example a discrete cosine transform or a wavelet transform.

It is an advantage of the invention that the watermark sequence may be shaped in the frequency domain. As models of the human auditory system may be well described in the frequency domain, a proper shaping of the watermark sequence is more prevalent in the frequency domain than in the time domain.

It is another advantage of the invention that the watermark sequence in the frequency domain may be readily used during detection of the watermark.

When the step of combining the convolution sequence with the information signal further comprises the steps of multiplying each sample of the convolution sequence by a predetermined scale factor to obtain a scaled convolution sequence, and adding the scaled convolution sequence to the information signal, the energy of the embedded watermark may be controlled by the scale factor. Hence, the embedding of the watermark may be controlled in order to satisfy the requirements of robustness and perceptibility of a given watermarking application.

When the step of calculating a convolution of the information signal with a watermark signal further comprises the step of performing an overlapped Fast Fourier Transform convolution, a computationally efficient way of calculating the convolution is provided. Examples of overlapped Fast Fourier Transform convolution methods include the so-called overlap-add and overlap-save methods known in the art of signal processing.

It is a further advantage of the invention that the spectral density of the convolution sequence is a scaled version of the original information signal, since it is known that a similarity between the information signal and the watermark sequence is beneficial from a security standpoint.

The invention further provides a method of subtracting a watermark, arrangements for embedding and subtracting a watermark, an information signal having an embedded watermark, a storage medium having recorded thereon such a signal, an arrangement adapted to detect a watermark in such a signal, a device for transmitting an information signal comprising an arrangement for embedding a watermark, and a device for processing multimedia content comprising an arrangement for subtracting a watermark. The above-mentioned aspects of the invention are disclosed in the independent claims. As the advantages and preferred embodiments of these aspects of the invention correspond to the advantages and preferred embodiments of the method described above and in the following, these will not be repeated here.

The invention will be explained more fully below in connection with preferred embodiments and with reference to the drawings, in which:

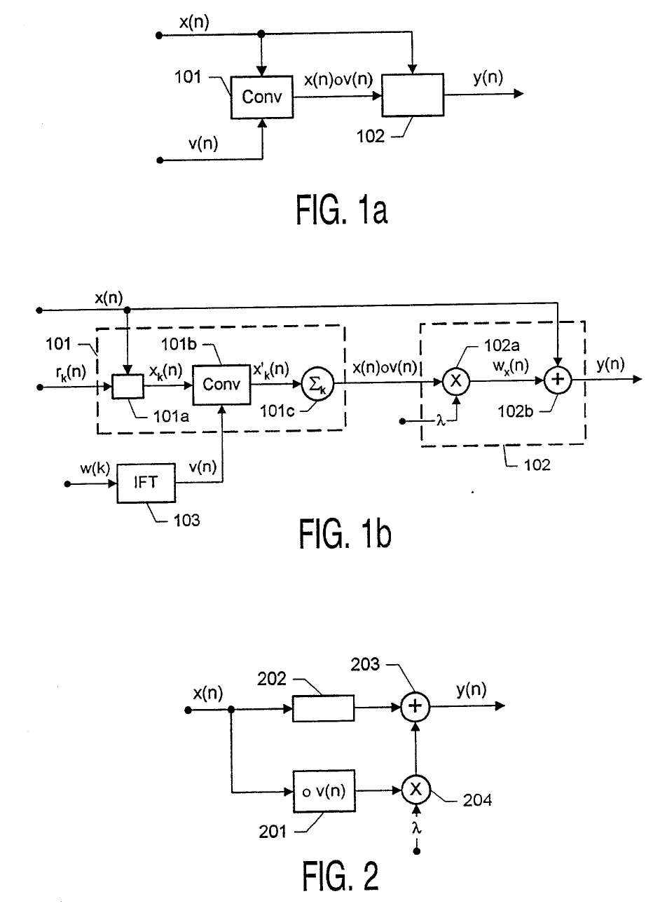

FIG. 1a shows a schematic diagram of a method of embedding a watermark according to a first embodiment of the invention;

FIG. 1b shows a schematic diagram of a method of embedding a watermark according to a second embodiment of the invention;

FIG. 2 shows a schematic diagram of an arrangement for embedding a watermark according to a third embodiment of the invention;

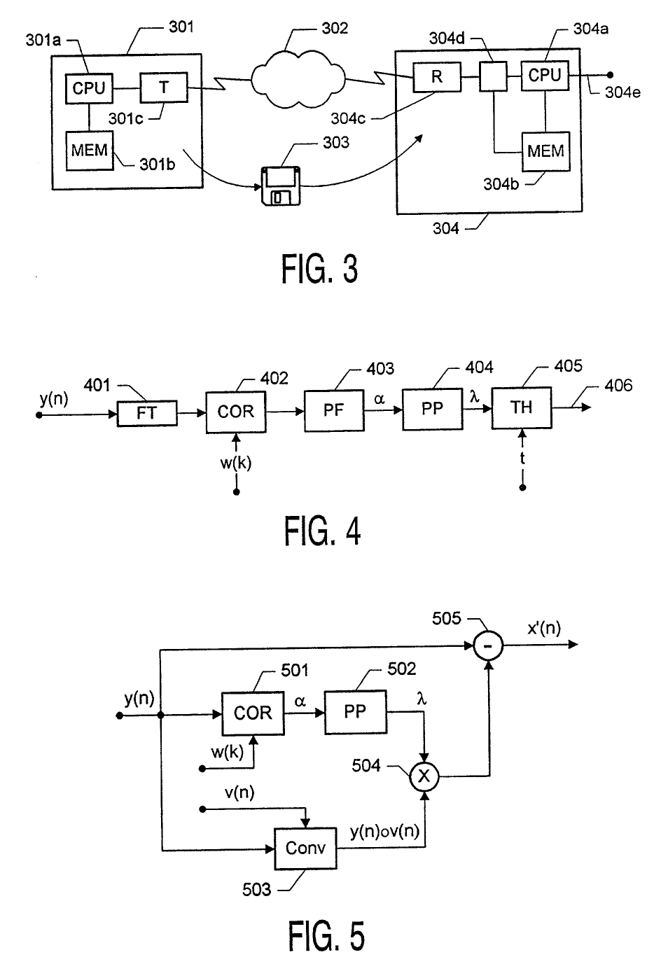

FIG. 3 shows a schematic view of a player receiving an information signal according to an embodiment of the invention;

FIG. 4 shows a schematic diagram of a method of detecting a watermark according to an embodiment of the invention; and

FIG. 5 shows a schematic diagram of a method of subtracting a watermark from an information signal according to an embodiment of the invention.

FIG. 1a shows a schematic diagram of a method of embedding a watermark according to a first embodiment of the invention. The method comprises the step 101 of calculating a convolution x(n)∘v(n) of the information signal x(n) with the key sequence v(n). Here and in the following, the operator ∘ represents a convolution, i.e. x(n)∘v(n) may be written as

x(n)∘v(n)=Σₖx(n−k)·v(k).

As x(n) and v(n) are not required to be periodic functions, x(n)∘v(n) is referred to as a non-cyclic convolution also known as linear or aperiodic convolution. The information signal x(n) is represented as a sequence of signal samples indexed by n. For example, in the case of an audio signal, n represents a discrete time. Therefore, we will refer to signals indexed by n as signals in the time domain. However, it is understood that for other types of information signals n may represent other coordinates, such as spatial coordinates. The watermark is represented by a key sequence v(n) in the time domain. Preferably, the key sequence has the following properties:

Preferably, v(n) is a pseudo-random key sequence with finite support. The length of v(n) may, for example, be in the range 500-5000 samples, e.g. 1024 or 2048 samples. A long key sequence allows a high watermark payload but, on the other hand, it may increase the distortion of the information signal, the delay and the complexity of the embedder. From an audibility point of view, a preferred choice of the length of v(n) may also depend on the sampling rate of the information signal.

More preferably, the key sequence v(n) comprises an odd number of samples, i.e. it may be represented by the samples v(n), n=−M, . . . , 0, . . . , M, where M may be, for example, 511 or 1023.

Preferably, the signal v(n) is generated such that its energy is equal to 1. This condition allows a simple control of the energy of the embedded watermark, as it ensures that under very mild assumptions the energy of the convolution x(n)∘v(n) is equal to the energy of x(n).

Preferably, v(n) is real, ensuring that the watermarked signal is real.

Preferably, v(n) is symmetrical, i.e. v(−n)=v(n). This has the advantage that it avoids phase distortions of the watermarked signal. It has the further advantage that the necessary number of operations of the embedding process is reduced, thereby reducing the complexity and cost of a circuit implementing the method of embedding.

Preferably, v(0)=0 and Σₙv(n)=0, i.e. v(n) has no DC component.

Still referring to FIG. 1a, in step 102 the convolution signal x(n)∘v(n) is combined with the information signal x(n), resulting in the watermarked signal y(n).

FIG. 1b shows a schematic diagram of a method of embedding a watermark according to a second, more efficient embodiment of the invention. According to this embodiment, the watermarked signal y(n) is calculated according to the expression:

x(n)—>y(n)=x(n)∘[1+λ·v(n)].

Here, λ is a predetermined embedding strength which may be used to control the energy of the embedded watermark in order to satisfy possible robustness and perceptibility constraints of a watermarking application.

Correspondingly, the step 102 of combining the information signal x(n) with the convolution x(n)∘v(n) described in connection with FIG. 1a further comprises a step 102a of multiplying the samples of the convolution x(n)∘v(n) by the embedding strength λ. In step 102b, the resulting watermark signal

wₓ(n)=λx(n)∘v(n)=λΣₖx(n−k)·v(k)

is added to the information signal x(n), resulting in the watermarked signal y(n).

Alternatively, the step 102 of combining x(n)∘v(n) with x(n) may comprise a subtraction, corresponding to a λ<0, or it may comprise another function, such as an XOR function in the case of a 1-bit audio format.

Hence, if v(n) has a finite support such that v(n)=0 for all n ∉{−M, . . . , 0, . . . , M}, the modification of a sample x(n) only depends on the key sequence, the embedding strength and the information signal in a certain neighbourhood x(n−M), . . . , x(n), . . . , x(n+M) around n.

It is also noted that the spectral density of wₓ(n) is a scaled version of the original signal x(n). Moreover, a listener listening to wₓ(n) may perceive the signal as being similar to listening to x(n) under special acoustic conditions. This similarity between wₓ(n) and x(n) is known to be beneficial from a security point of view.

Furthermore, according to this embodiment of the invention, in step 103 the key sequence v(n) is derived from a watermark sequence w(k) by calculating the inverse Fourier transform of w(k) prior to calculating the convolution x(n)∘v(n) in step 101. If the information signal x(n) represents an audio signal in the time domain, the watermark sequence w(k) corresponds to the frequency components of the key sequence v(n). Hence, as the shaping of a watermark signal according to a model of the human auditory system is preferably done in the frequency domain, it is advantageous to take w(k) as a starting point. Furthermore, w(k) may directly be used as an input to a detection arrangement for detecting the presence of the watermark w(k) in a signal, as will be described in connection with FIG. 4. Preferably, w(k) has the following properties:

Preferably, w(k) is a real, symmetrical and pseudo-random sequence with finite support to ensure that v(n) is real, symmetric and with finite support.

Preferably, w(k) is DC-free, i.e. Σₖw(k)=0. This further ensures that v(0)=0.

Furthermore, the convolution performed in step 101 is performed using an efficient method, which reduces the complexity of implementing the convolution operator. A direct computation of the convolution x(n)∘v(n) is computationally expensive. However, an efficient way to overcome this complexity is to use an overlapped Fast Fourier Transform convolution method, also known as overlapped FFT filtering. According to this method a window function r(n) is used, e.g. a rectangular window function whose support is larger than the support of v(n). Using this window function, a set of shifted window functions rₖ(n)=r(n−k·N) may be defined with N being the width of the window function. Preferably, the rₖ(n) define a division of one, i.e. Σₖrₖ(n)=1. Hence the convolution x(n)∘v(n) may be written as

$$\begin{matrix}x ( n ) • v ( n ) = v ( n ) • [ {\sum }_{k} x ( n ) \cdot r ( n - kN ) ] \\ = {\sum }_{k} v ( n ) • [ x ( n ) \cdot r ( n - kN ) ] \\ = {\sum }_{k} v ( n ) • {x}_{k} ( n ) = {\sum }_{k} {x}_{k}^{′} ( n )\end{matrix}$$

where xₖ(n)=x(n)·r(n−k·N) and x′ₖ(n)=v(n)∘xₖ(n), i.e. the large convolution may be replaced by a sum of convolutions between functions with limited support.

Furthermore, r(n−kN) may be defined such that it comprises sufficiently many zeros at the boundaries to ensure that all cyclic wrap-around terms for a cyclic convolution cancel. Hence the convolutions v(n)∘xk(n) are equivalent to cyclic convolutions and may, therefore, be calculated efficiently using Fast Fourier Transforms (FFTs) and multiplications. For example, in the case of a one-dimensional audio signal x(n) and a watermark signal v(n) of length L, the above method may be implemented using Fast Fourier Transforms of size 2L.

In the embodiment of FIG. 1b, this method is implemented by the step 101 which comprises step 101a of multiplying the information signal x(n) by the shifted window functions rₖ(n) to obtain the functions xₖ(n). Subsequently, in step 101b, the convolutions of v(n) with the xₖ(n) are calculated using FFTs. In step 101c, the resulting partial convolutions x′ₖ(n) are then summed over.

It is a further advantage of this embodiment that it operates in the frequency domain and involves the limited support signals xₖ(n). Consequently, the embedding of the watermark may be adapted to the local perceptual characteristics of the frequency spectrum of the signals xₖ(n), especially if r(n) has a sufficiently smooth roll-off.

Hence, this embodiment of the invention both reduces the computational complexity and serves the incorporation of a perceptual model in a non-frame-based method based on the global information signal.

It is further noted that the overlapped method of calculating the convolution described above corresponds to the so-called overlap-add method. Alternatively, the so-called overlap-save method may be used.

FIG. 2 shows a schematic diagram of an arrangement for embedding a watermark according to a third embodiment of the invention. The arrangement comprises a convolution circuit 201 taking the information signal x(n) as an input and generating as an output a convolution of x(n) with the key sequence v(n). The convolution is fed into a multiplication circuit 204 which performs a multiplication with the embedding strength k. The output of the multiplication circuit 204 is fed into a summing circuit 203 which also takes the original information signal x(n) as an input and generates as an output the watermarked signal y(n) as a sum of the watermark signal and the information signal x(n). Preferably, in order to compensate for the delay introduced by the convolution circuit 201, the information signal x(n) is passed through a delay circuit 202 prior to feeding it into the summing circuit 203. The convolution circuit 201 may be a finite impulse response (FIR) filter with impulse response coefficients v(n). Alternatively, if the key sequence v(n) comprises an odd number of samples, the impulse response coefficients of the convolution filter 201 may be chosen to be λv(−M), . . . , λv(−1), 1, λv(−1), . . . , λv(M). Hence the filter performs the operation ∘(1+λv(n)) and the two paths of the arrangement of FIG. 2 may be replaced by one path, thereby saving the delay circuit 202.

Alternatively, the multiplying circuit 204 and the summing circuit 203 may be replaced by other circuits implementing a different combination of x(n) with x(n)∘v(n), as described in connection with FIGS. 1a-b.

Furthermore, it is understood that the convolution circuit 201 may comprise means to perform the convolution as an overlapped FFT filtering, as described in connection with FIG. 1b.

It is also understood that the arrangement of FIG. 2 may further comprise an inverse Fourier transform circuit which generates the key sequence v(n) as an inverse Fourier transform of a watermark sequence w(k), as described in connection with FIG. 1b.

FIG. 3 shows a schematic view of a player receiving an information signal according to an embodiment of the invention. The player 304 comprises a receiver 304c for receiving a communications signal from a signal source 301 via a communications network 302. The received signal is forwarded, via a watermark detection circuit 304d, to a processing unit 304a for further processing and/or storing in a storage medium 304b. The storage medium 304b may comprise a magnetic tape, optical disc, digital video disk (DVD), compact disc (CD or CD-ROM), mini-disc, floppy disk, a smart card, ferro-electric memory, electrically erasable programmable read only memory (EEPROM), flash memory, EPROM, read only memory (ROM), static random access memory (SRAM), dynamic random access memory (DRAM), ferromagnetic memory, optical storage, charge coupled devices, etc. The information signal may comprise multimedia content, such as audio, video, still images, graphics, animation, or the like.

The further processing may comprise playing, recording, displaying the multimedia content, performing other signal processing operations, generating a control signal 304e for further processing, or the like. The watermark detection circuit 304d may detect a watermark in the received signal, for example using the embodiment of a detection method described in connection with FIG. 2, and forward the corresponding watermark information to the processing unit 304a and/or store the corresponding information on the storage medium 304b. Based upon the result of the detection, the processing unit may, for example, restrict the playing, storing and/or copying of the information signal. Alternatively or additionally, the processing unit 304a may comprise a programmable microprocessor, and the storage medium 304b may comprise computer-executable program code which when loaded in the processing unit is adapted to perform the method of detecting a watermark. Alternatively, the processing unit may comprise an application-specific integrated circuit, or another integrated circuit, a smart card, or the like.

The signal source 301 may comprise a transmitter 301c for transmitting the signal via the communications network 302, a processing unit 301a adapted to embed a watermark in the information signal, and a storage medium 301b for storing the original information signal, the watermark and relevant system parameters.

The communications network may be a telecommunications network, a computer network such as a LAN, WAN, an intranet or the Internet, a television or radio broadcast network, or the like. Alternatively, the information signal may be sent via another storage medium 303, such as magnetic tape, optical disc, digital video disk (DVD), compact disc (CD or CD-ROM), mini-disc, floppy disk, smart cards, or the like.

FIG. 4 shows a schematic diagram of a method of detecting a watermark according to an embodiment of the invention. This embodiment of the invention utilises the observation that the two terms x and λ·v∘x in the expression y=x+λ·v∘x are statistically orthogonal. Therefore, the embedding strength λ of a watermarked signal y may be estimated from

$$α = \frac{2 λ}{1 + {λ}^{2}} = ⟨ \frac{y • \overline{y}}{{‖ y ‖}^{2}} , \begin{matrix}v \\ 35\end{matrix} ⟩ ,$$

where the bar operator denotes time reversal, i.e. an inversion of the order of the indices n of the discrete signal y(n), and the <,> denotes the inner product. Correspondingly, a method of detecting a watermark embedded according to the invention may comprise a step 401 of windowing, Fourier transforming, and possibly further processing the input signal y(n) which is to be analysed for a watermark. In a subsequent step 402 the resulting Fourier coefficients are correlated with a watermark sequence w(k). The sequence w(k) may be obtained by Fourier transforming the key sequence v(n) or, preferably, if the key sequence v(n) was derived as an inverse Fourier transform of w(k), the original w(k) may be used directly. Subsequently, in step 403, a dominant peak in the correlation spectrum is identified and a correlation value α is calculated. Using the above relation, the embedding strength λ may be estimated in a subsequent post-processing step 404. Finally, in step 405, the embedding strength is compared to a predetermined threshold value t, resulting in a control signal 406 indicating the presence or absence of the watermark and/or the payload of the watermark.

It is understood that other transformations than Fourier transformations may be used in the method of detecting a watermark according to the invention, for example discrete cosine transforms of wavelet transforms.

FIG. 5 shows a schematic diagram of a method of subtracting a watermark from an information signal according to an embodiment of the invention. According to this embodiment of the invention a watermark may be extracted/substantially removed from an information signal by calculating an estimated embedding strength. The method comprises a step 501 of calculating a correlation value α between an information signal y(n) and a watermark sequence w(k). Preferably, the calculation is performed in the Fourier domain, as described in connection with FIG. 4, where w(k) is a Fourier transform of a watermark signal v(n), and where the step 501 of calculating the correlation value further comprises the steps of segmenting the information signal into frames and Fourier transforming the frames. As described in connection with FIG. 4, according to the invention, the correlation value α is related to the embedding strength λ of the watermark signal calculated as a convolution of an original signal x(n) with a watermark signal v(n), where the relation between α and λ may be expressed by the relation α=2λ/(1+λ²). Correspondingly, the method according to the embodiment of FIG. 5 comprises the step 502 of calculating the estimated embedding strength λ using the relation α=2λ/(1+λ²). The method further comprises the step 503 of calculating a convolution of the input signal y(n) with the watermark signal v(n). Preferably, the convolution may be calculated using the method described in connection with FIG. 1b. Subsequently, the convolution signal is multiplied 504 by the calculated embedding strength λ and subtracted 505 from the information signal y(n) to obtain a signal x′(n) where the watermark is subtracted.

It is noted that the subtraction of the convolution may be performed by an arrangement like the one described in connection with FIG. 2, where the summing circuit 203 is replaced by a subtraction circuit, and where λ is calculated according to the method described above.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, disclosed is a non-frame-based method and an arrangement for embedding a watermark in an information signal (x(n)), e.g. an audio signal. The method comprises calculating a non-cyclic convolution of the information signal with a watermark signal (v(n)) and combining the convolution with the information signal. The non-cyclic convolution may be calculated by overlapped Fast Fourier transform filtering.

1. A method of embedding a watermark in an information signal (x(n)), the method comprising the steps of
calculating a convolution of the information signal with a predetermined key sequence (v(n)) representing the watermark to obtain a convolution sequence (x(n)∘v(n)); and
combining the convolution sequence with the information signal.

2. A method according to claim 1, further comprising the step of generating the predetermined key sequence by calculating a transform of a predetermined watermark sequence (w(k)).

3. A method according to claim 1, wherein the step of combining the convolution sequence with the information signal further comprises the steps of
multiplying each sample of the convolution sequence by a predetermined scale factor (λ) to obtain a scaled convolution sequence; and
adding the scaled convolution sequence to the information signal.

4. A method according to claim 3, wherein the predetermined scale factor is locally adapted.

5. A method according to claim 1, wherein the step of calculating a convolution of the information signal with a watermark signal further comprises the step of performing an overlapped Fast Fourier Transform convolution.

6. A method according to claim 1, wherein the predetermined key sequence corresponds to a predetermined energy.

7. A method according to claim 1, wherein the information signal comprises a multimedia signal, selected from the class of multimedia signals including audio signals, still image signals, and video signals.

8. A method of subtracting a watermark from an information signal (y(n)), the method comprising the steps of
correlating (501) a first watermark sequence (w(k)) representing the watermark with a first signal derived from the information signal to obtain a correlation value (α);
calculating (502) an embedding strength value (λ) from the correlation value (α);
calculating (503) a convolution of the information signal with a second watermark sequence (v(n)) representing the watermark; and
subtracting (504) the calculated convolution multiplied by the calculated embedding strength value from the information signal.

9. A method according to claim 8, wherein the embedding strength value λ is calculated from the correlation value α using the relation α=2λ/(1+λ²).

10. An arrangement for embedding a watermark in an information signal, comprising
means (201) for calculating a convolution of the information signal with a predetermined key sequence representing the watermark to obtain a convolution sequence; and
means (203, 204) for combining the convolution sequence with the information signal.

11. An arrangement for subtracting a watermark from an information signal, the arrangement comprising
means for correlating a first watermark sequence representing the watermark with a first signal derived from the information signal to obtain a correlation value;
means for calculating an embedding strength value from the correlation value;
means for calculating a convolution of the information signal with a second watermark sequence representing the watermark; and
means for subtracting the calculated convolution multiplied by the calculated embedding strength value from the information signal.

12. A device for processing multimedia content, the multimedia content being included in an information signal, the device comprising an arrangement for subtracting a watermark from the information signal including
means for correlating a first watermark sequence representing the watermark with a first signal derived from the information signal to obtain a correlation value;
means for calculating an embedding strength value from the correlation value;
means for calculating a convolution of the information signal with a second watermark sequence representing the watermark; and
means for subtracting the calculated convolution multiplied by the calculated embedding strength value from the information signal.

13. An information signal having an embedded watermark, wherein the information signal has been generated by calculating a convolution of a source signal with a predetermined key sequence representing the watermark to obtain a convolution sequence, and combining the convolution sequence with the source signal to obtain the information signal.

14. A storage medium having recorded thereon an information signal according to claim 13.

15. An arrangement adapted to detect a watermark in an information signal according to claim 13.

16. A device for transmitting an information signal, the device comprising an arrangement for embedding a watermark in the information signal, the arrangement including
means for calculating a convolution of the information signal with a predetermined key sequence representing the watermark to obtain a convolution sequence; and
means for combining the convolution sequence with the information signal.
